(19) United States
(12) Patent Application Publication
(10) Pub. No.: US 2024/0134592 A1
(43) Pub. Date: Apr. 25, 2024

(54) Information Display

(71) Applicants: A Ray Chaudhuri, San Rafael, CA (US); Dean Nakamura, Montgomery Village, MD (US)

(72) Inventors: A Ray Chaudhuri, San Rafael, CA (US); Dean Nakamura, Montgomery Village, MD (US)

(21) Appl. No.: 17/953,230

(22) Filed: Sep. 26, 2022

Related U.S. Application Data
(63) Continuation of application No. 16/601,840, filed on Oct. 15, 2019, now abandoned.
Application No. 16/601,840 is a continuation of application No. 15/578,234, filed on Nov. 29, 2017, now abandoned.

(51) Int. Cl. G06F 3/147; G06Q 30/0251; G09F 27/00

(52) U.S. Cl. CPC G06F 3/147; G06Q 30/0251; G09F 27/00; G06Q 30/0272

(57) ABSTRACT

A device to display variable information received wirelessly from a remote computer is described. The device can be part of a sign, can be presented on a building or can be presented on a vehicle. The device displays any of a variety of images, whether still or moving.

### FIELD OF THE INVENTION

The subject matter relates to materials and methods for creating a platform for electronically disseminating and displaying varying information, such as, warnings or advertisements, on, for example, a building or a motor vehicle, on demand.

### BACKGROUND OF THE INVENTION

Information dissemination is provided on buildings, billboards, vehicles and so on by signs, banners, labels and so on. Such generally are static and affixed to a site, structure, vehicle and the like by, for example, an adhesive means, a magnetic means, fasteners and so on.

However, because those forms of display are fixed for particular content, particular displays must be replaced or removed when obsolete.

An advantage can be provided by employing an electronic display device that is adaptable to presenting a plurality of display material on demand and of design choice, optionally in a revenue generating scheme, that is in communication with an information distribution device that provides instructions and data comprising a display content to that display device, which image(s) can be displayed, for example, on, in or outside a structure, a building, a vehicle and so on.

### SUMMARY OF THE INVENTION

The instant subject matter provides such advantages, improvements and more by providing electronic means and devices for presenting varying display material, an electronic image, on a surface (interior or exterior, internal or external), such as, a glass, a window or a wall, for example, on a building, on a moving or stationary vehicle, and so on. An electronic system enables a display device to present a plurality of or variable display material of differing informational content at the behest of informational content owners, an operator, a lessee, a renter, an owner, a driver of a vehicle and so on. An electronic means or device of interest can comprise a wireless communication means or device that enables digitized information to be transmitted to and from an electronic device of interest from and to a remote data dissemination or distribution device, and between or among devices of interest sited in buildings, vehicles and so on. An electronic device of interest can comprise a data storage and processing ability, such as, a central processing unit and a data storage device, to enable processing and storing of data, a digitized form of display material, software and so on for operation of an electronic display device of interest, to provide instructions for and to enable display of images, and information, such as, metadata, to enable tracking of display and usage information, as well as ability to enable storage of information, to enable data analysis, to enable communication with other computers and so on. An electronic device of interest comprises a display means or device that displays images, information and the like, for example, in, on or outside a vehicle, for example, by a head up display; in, on or outside a building; in, on or outside an office; and so on.

In embodiments, a fixed or portable device of interest can enable tracking of images displayed, length of display, location at which information is displayed and so on, which facilitates gathering data on efficacy of information display and downstream events resulting from said display. A device of interest can provide a means of marketing revenue generation or sharing based on information display.

Those and other objects were attained in development of the instant subject matter of interest, which is described in further detail below.

### DETAILED DESCRIPTION OF THE INVENTION

The subject matter of interest relates to an electronic information content distribution or dissemination device that stores and sends electronic information content and display information to a remote information display device of interest, for example, by a wireless interface, means or device, such as, and using, for example, radio waves, microwaves, free-space optical devices, Bluetooth technology and so on using, for example, a satellite-based communication network, wireless devices, (known as Wi-Fi, which loosely means wireless fidelity), a light fidelity (Li-Fi) device, a cell tower and so on. That disseminated information and content data file is captured in an information or data retrieval device of an electronic device of interest which is in communication with an information display device of interest that presents the desired content. Both data retrieval and data display devices can be portable and can be located on or in a vehicle, a building and so on. A retrieval device transmits digitized information content to a display device which displays material content, such as, an image, for example, on one or more surfaces, such as, panels or windows of a building or a vehicle, which image is variable and is changeable, as a design choice, without any physical manipulation of a device of interest, a display change occurring by processing and displaying different computer programs, data files and so on instead. Thus, physical content and structure of a device of interest does not change with each new and different display, it is only displayed electronic information and content that changes with a second or more display.

By, “vehicle,” is meant any means of transportation that provides a venue or foundation for operation of an electronic device of interest. Examples of vehicles include automobiles, buses, trains, airplanes and other aircraft, wagons, scooters, rickshaws, trams, boats and other watercraft, other wheeled vehicles, trams, gondolas, amphibious vehicles, tracked vehicles, driverless means of transportation, such as, a driverless or autonomous vehicle, such as, an automobile, bicycles or other non-motorized, wheeled vehicles, any vehicle that comprises a motor, such as, an electric motor, a gasoline motor, a nuclear motor, a solar powered vehicle, wave or wind capture and conversion powered motor, other “green” power sources and so on, or other means of transportation.

In embodiments, information of interest is displayed outside of a building, an office or a vehicle and so on. An office can be located within a building, such as, a tenant business in a mall. In that case, while a displayed image is inside of a building, that displayed image nevertheless is displayed outside of an office or place of business.

In embodiments, information of interest is displayed inside of a building, an office or a vehicle, such as, on an inside face of a window of a passenger of an airplane, a bus or a train, an inside face of a window of a taxi or of a driverless vehicle and so on.

By, “proper,” image is meant an image that is, for example, right side up, not inverted, not upside down, not backwards and so on, that is, letters and numbers, for example, are readable by a viewer, and objects are presented and positioned as an original, or as in an original, text (in any language), object, picture, scene, acts, actions, structure and the like as presented in a manner that an image coveys or connotes intent, content, message and the like as of the original. Thus, as used herein, a proper image is one readable and intelligible by a viewer and intent of an image owner or original owner is conveyed to a viewer. A proper image may be one which faithfully reproduces an original. It is recognized that in circumstances, an image may not reproduce faithfully an original yet nevertheless conveys intent of an image owner or an original owner. For example, palindromic words are readable both forward and backward. (An imperfect image of a palindrome may be detectable, for example, if letters comprise different colors.) A circular pie chart without any numbering or lettering may be presented upside down, inverted, backwards and so on without detracting from conveying requisite information to a viewer no matter orientation or presentation of an image thereof. On the other hand, some letters and numbers are stereospecific (for example, the letter, “I,” and, “8,” can be viewed properly in forward or backward orientation and are denoted herein as, “not stereospecific,” whereas, “B,” and, “2,” only can be read properly in forward direction and are identified herein as, “stereospecific.”) Hence, an image, although not a faithful reproduction of an original, for example, may be palindromic or similar to the example of a circular pie chart sans lettering and numbering above, nevertheless is readable or is intelligible by a viewer and conveys intent of an image or original owner, even though an image does not faithfully reproduce an original. Thus, non-faithful reproduction of an original is a proper image for purposes herein because although not identical to or not faithfully reproducing an original, such an image is readable and intelligible by a viewer and that image conveys intent of an owner of an image or of an owner of an original, such as, a sign, a text (in any language), a picture, a video and the like, which is basis of an image of interest, to a viewer.

By, “display,” is meant any digitized information or material that is transformed to result in a visible and visual material, for example, an image, a picture, a video, a text and the like, which is perceived by a viewer. For example, in the case of a head up display (HUD) device, display comprises an image on or of a combiner. Display also denotes a device that presents, for example, an image, such as, a CRT, an LED, a plasma display and so on.

By, “image,” is meant a likeness or representation of an original, an optical counterpart of an object, a visual perception of an original and so on, as known in the art. An image may be two-dimensional, three-dimensional and so on. An image may be static or still; or kinetic, that is, moving or a moving image, and can be a video, a stream, a movie, a zoetrope, an animation, a virtual reality environment, a simulated reality environment, an augmented reality environment and so on; may be obtained by taking a digital photograph or a digital video with a camera; and so on. Information for producing an image in a suitable display device of interest is storable as a data stream, a program, a file and so on in a data storage device.

By, “owner,” is meant one who creates and/or possesses ownership or title of, for example, displayed information. Hence, an owner can be a photographer, an artist, a graphic artist, a painter, someone who creates a sign, a video, a movie, a poster and so on, and so on. An owner, licensee or one working under direction of an owner, if not already done or already so, can create a digital file, program or code of instructable information or data for storage, transmission, processing and display of the original, which information is displayed as an image which is identical to, resembles an original or is a proper image. A data file for creating an image of an original is owned, for example, by an owner of an original, unless contracted to the contrary.

By, “variable,” “varying,” grammatic forms thereof or equivalents thereof is meant more than one, for example, electronic image. Any change of an image, for example, size, overall color or a color presented therein (such as, of a particular object of several in an image), a modification thereof and so on constitutes a second image. In the context of a device of interest, because a medium displaying information content is electronic, and an image is constructed and displayed by an instructable basic palette, which generally is represented by an array or map of elements, such as, a pixel, which may be coupled to a charge-coupled device (CCD) or complementary metal oxide semiconductor (CMOS) chip, a diode, a vector and so on that can relate to a raster graphic, a bitmap, a pixmap and so on, where each element receives or not, an electrical signal and responds by generating a light, not generating a light or generating an intermediary signal that then generates a light, where an image is created by an array of elements, such as, a cathode ray tube (CRT), a light emitting diode (LED) device, a liquid crystal display (LCD), an HUD and so on, that device can be instructed or made to display a first image, a second image, a third image and so on image, sequentially. For example, one advertisement can be displayed on Monday, a second, different advertisement can be displayed on Tuesday and so on by and on a single display device of interest. A variable or varying image also comprises a moving image, such as, a video, a stream, a movie and so on. Varying images are generated electronically and not manually, that is, for example, by replacing one placard sign with another for placement within a frame. The subject matter of interest comprises variability arising from displaying different digital data files or a large data file comprising data encoding multiple images, resulting in different electronic images in a single display device of interest.

By, electronic,” grammatic forms thereof or equivalent forms thereof is meant, in the context of subject matter of interest, what is obtained by a viewer, that is, an image of interest perceived by a viewer, is generated or provided using electricity or electric energy (no matter how produced, including “green” sources), and various electric devices to generate or to create an image. Hence, for example, a bulb, a diode, a pixel, an LCD and other display devices taught herein and known in the art which require electricity to operate and to generate an image are contemplated as electronic devices of interest. For purposes herein, unless indicated otherwise, “electronic,” “electricity,” “electric energy,” and “electric power,” are used synonymously and interchangeably. Electronic is distinguished from display devices that relate to physical signs; printed materials, drawn materials, painted materials, stenciled materials and so on; placards; paintings; painted signs; decals; a graphic line art; a label; a metal-based image; a plastic sign; and so on, items that relate to a manual and tangible presentation of information. Hence, an electronic display comprises a single platform, a palette and so on comprising an array of elements to generate electrically, any of a variety of images based on a data file being processed and used to generate an image. That is different, for example, from a neon sign, which, although may comprise multiple tubes of glass to generate a moving image by alternating electric current to different tubes, which may contain different fluors, a neon sign is not variable to the extent of receiving electronic digital data files that can display any of a plurality of images. A neon sign can only present a static, non-variable image or portion thereof using a single, bent glass tube.

By, “distribution device,” “data distribution device,” grammatic forms thereof or equivalents thereof is meant a data storage, data processing and data disseminating device that is a wireless source of a digital data file of informational content for display of an image by a display device of interest. A synonymous term is, “dissemination device,” or any other word, term or phrase that connotes, “send,” or, “transmit.” For example, a distribution device can be a, for example, a computer or a server comprising a central processing unit (CPU) and a device for wireless communication. A distribution device is not attached physically to a display device of interest. A distribution device can be in wireless communication directly with a display device of interest or indirectly through an intermediary device, such as, a satellite, a cellular telephone tower, a wireless hot spot, a cellular telephone, a computer, a router, a light fidelity device, a server, a network and so on which accepts data from a distribution device and then transmits that data to a display device of interest. A distribution or dissemination device can be a singular device or a plurality of devices, which can be in communication therebetween or thereamong, for example, located at different geographic regions, located at plural sites in an area of high volume content display, located at plural sites in an area of a large number of display devices and so on.

A, “retrieval device,” “data retrieval device,” grammatic forms thereof or equivalents thereof is a component of a device of interest and comprises a device that receives wireless communications, a wireless data stream and so on. Data received comprises that which originates at or from a distribution device, directly or indirectly via an intermediate device, such as, a satellite, cell tower, cellular telephone, a hot spot and so on. Thus, a device of interest comprises an antenna or other data retrieval device that receives a wireless data stream, for example, by radio or microwave, comprising to be displayed informational content in digital form and communicates that information, for example, to a data display device or a storage device of interest, where that information can be accessed, processed and made to be displayed on a display device of interest. Information received by an antenna or other data retrieval device can comprise executable programs and code for displaying information content of interest, as well as files comprising data encoding an image or other informational content to be displayed. Alternatively, programs for displaying information content on and by a display device of interest can be downloaded from a distribution device onto an electronic device of interest comprising a data storage device, a data processing device and a display device for storage and use. Then, a distribution device can transmit data files comprising information or code of information content of interest, that is, to be displayed, such as, an image, a video and so on to a display device of interest, which data file is processed by a previously downloaded and stored executing program and the resulting image, video and the like of the downloaded data file is displayed in, on and by a display device of interest. Thus, information content disseminated can include along with data of information content, other programs and code, for example, for displaying information, for retrieving and storing data relating to displayed content and so on, which can be considered metadata of displayed content, which can include data on characteristics of a display, such as, date and time of day of display, length of time of display, geographic location of display and so on.

A, “display device,” “data display device,” grammatic forms thereof or equivalent forms thereof is a component of a device of interest which displays to a viewer desired information content. A display device thus can be an electronic sign comprising, for example, a cathode ray tube (CRT), a liquid crystal display (LCD), a plasma display, a light emitting diode (LED) display, organic or inorganic, other devices that electronically display letters, numbers, pictures, images and the like, and so on. A solid state light source comprises a diode, such as, an LED, an organic LED, a polymer LED and so on. A display device can present a static image, sequential images or moving images, such as, a film or a video. Information (data, for example, in the form of a program or code, comprising information coding a displayed image(s) or a data file comprising information coding a displayed image), obtained by a retrieval device of interest is stored and processed in a device of interest, which then is communicated (in proper format, for example, analog or digital depending on a display device) to a display device where information is interpreted, resolved and executed in a display device resulting in presentation of an image or images perceptible by a viewer.

In embodiments, a display device can be a panel or a planar display structure, such as, a plasma display, an LCD, an LED display and so on, which is affixed to a surface, such as, to a wall of a building or other structure; to a panel of a vehicle, such as, an automobile; comprising a sign structure, for example, attached or affixed to an automobile, such as, structures attached to or appearing on a roof of an automobile bearing physical signage; comprising a sign, such as, a billboard; to a window or to a wall of an office of a building; and so on. For purposes herein, a, “structure,” is any physical entity to which a display device of interest can be affixed, attached, incorporated in, a component thereof, situated in parallel therewith and so on is associated with a surface thereof.

In embodiments, a display device is one which projects an image onto a surface, such as, a projector. Generally such devices project images onto a neutrally colored surface. Hence, in embodiments, any surface can be used as a surface or screen for viewing a projected image so long as there is contrast between an image and a surface to enable a viewer to perceive that image.

In embodiments, a display device is one which displays images on a transparent or translucent surface, essentially, a surface that is clear or somewhat clear, wherein a scene, object, signage, structure, person, animal, landscape and so on is viewable from a side of that surface, for example, on a surface, through that surface and so on, such as, a window or a windshield, by a viewer. In embodiments, a display device is an HUD or similar technology that enables images to be visualized on a clear, transparent or translucent surface, although HUD technology is operable on other colored or opaque surfaces. For example, a window, on a building or of an automobile, may comprise transparent phosphors that react and emit a light when impinged with laser light to create an image on or in that window, whether internal (interior), external (exterior) or both. In embodiments, with a projector, an image is projected using, for example, a CRT, a solid state light source, an LCD, a laser, a liquid crystal on silicon device, a digital micromirror or nanomirror device and so on. In embodiments, a wave guide is used which avoids image projection, using, for example, total internal reflection or total internal refraction. Other holographic, refraction or diffraction optics can be used, see, for example, U.S. Pat. No. 8,749,890, herein incorporated by reference in entirety. An HUD also can include a collimator, collimating optics or collimating device, using, for example, diverging and/or converging lens, a fold prism, a convex mirror, a beam splitter and so on, to provide a perceived unlimited focal length or an image with a focal point of infinity. An HUD comprises a combiner or other device that accepts a projected image (or an image or a signal, for example, in the case of a wave guide) and acting, for example, as a beam splitter, redirects light and displays an image in or on a surface to which a combiner is placed in parallelwise or facewise orientation therewith, such as, a planar structure placed in parallel orientation with a surface, for example, laid next to or on a surface, as a film applied to a surface, as a component of a surface and so on, to a viewer. Generally, a viewed image is in a different plane from that of an image directly projected from a projector or an image at the beginning of a wave guide. Thus, it is not uncommon for an image to be redirected to be perceptible by a viewer. As known in the art, depending on an optical device or system used, an image can be projected, for example, upside down, backwards, right side up, forwards, inverted, as a mirror image, a real image and so on so as to be a proper image, an image that is readable and interpretable by a viewer, such as, an image projected on an outside surface of an automobile or on a side or wall of a building. Also, as known in the art, one or more lens, mirrors, contoured or textured films, diverging lens, converging lens and so on, which may involve reflection, refraction, total internal reflection, total internal refraction, diffraction and other optics phenomena, to address light (generally, direction) changes that arise at boundaries or in layers or with media of differing optics properties, can be used to ensure an image perceived by a viewer is proper, an image is readable and is interpretable no matter orientation or presentation. As known in the art, as automobile windows generally are laminates of plural panes of glass, often, a film or plural films can be present between adjacent panes or on a face of a pane, such as, a surface facing inside or a vehicle cabin or cab, for example, to reduce transmission of sunlight into a vehicle. In embodiments involving an HUD in BMW automobiles, a wedge-shaped film is present between panes to redirect light and to ensure only a single image is perceived by a driver (without a wedge-shaped film, light reflecting from different boundaries and refracting from different media produce overlapping images, resulting in a blurred or indistinct image.) For surfaces that are not planar or where a projection system or device of interest projects images with aberrations, as known in the art, one or more mirrors, lens, films and so on for correcting an image or for projecting an image on a non-planar surface which when viewed is not distorted, can be used. Corrective or modifying optical devices can be present in a combiner, in a surface accepting an image, in a projector and so on, or combination thereof.

For example, an HUD can be used in the practice of the subject matter of interest, see for example, U.S. Pat. Nos. 7,643,215; 7,688,516; and 7,675,683, each of which is incorporated herein by reference in entirety. An HUD generally comprises a combiner which is appended to or incorporated in a glass pane, generally of a vehicle. An image can be delivered or can be projected by a CRT, an LCD device, an LED device, an LCD on silicon device, a digital micromirror, a laser (see, for example, US Publ. No. 20150062345, incorporated herein by reference in entirety), an organic LED and so on.

As alluded to above, an electric device of interest can comprise a plurality of parts or devices, including, at the least, a display device, a data storage device and a data processing device, and, optionally, a data retrieval device to accept data streams from a distribution or dissemination device, wireless digitized information communications comprising code for displaying informational content, a data transmitting device for transmitting information or data, for example, to a distribution device, and so on. The various components can be assembled into a single structure, or segregated between or among plural structures, as a design choice. As used herein, a display device of interest comprises a particular display device, such as, an HUD, or a display device along with other devices for operation of same, such as, a data storage device, a data processing device, a wireless data retrieval device and so on, and combinations thereof.

There may be a single electronic information distribution device or a plurality of such distribution devices, optionally those plural distribution devices can be in communication therebetween or thereamong, wherein said distribution devices can be sited geographically about an area to ensure ready communication to retrieval devices of interest. In areas where a large number of retrieval devices are concentrated, a larger number of distribution devices can be located in proximity to ensure timely and ready transmission of data to each retrieval device.

A distribution device can comprise a digitized data operating system, such as, a CPU, a computer, such as, a server, as known in the art. An operating system thereof can comprise a data storage device, a data processing device, a data communication device, a data display device and so on as a design choice. An operating system includes not only data or files to operate a device for accepting and sending data files of displayed material, but also comprises data and ability to store files of displayed material, such as, images; devices and ability to receive, to send or to transmit files of displayed material; to display information to be viewed; code or programs to track display of material; and so on, as known in the art. Material can be of informational content, entertainment content and the like, such as, warnings, advertisements, pictures, videos and so on, as well as combinations thereof. Thus, any information that can be digitized and then displayed by a display device of a device of interest can be used in practice of the instant subject matter.

A data communication means or device of a distribution device and of an electric device of interest, which device of interest is remote from a distribution device, comprises wireless technology and can be of any form as known in the art, such as, a means or device that receives and sends microwaves, radio waves, infrared radiation and so on as a medium or means for communicating information in the form of digitized data. To enable access to a large number of users, for example, a satellite may be employed. Global positioning satellites (GPS) and other tracking or locating technologies enable geographic siting and monitoring of a device of interest. However, constant communication with a distribution device is not needed, although may be desirable, particularly if a device of interest also is obtaining data about information display, for example, metadata dissemination regarding displayed content and other ancillary information, such as, location of a device of interest and so on, and storing that data, which then can be transmitted to a, for example, distribution device, see, for example, U.S. Pat. No. 7,397,345 relating to sending electronic advertisements and US Publ. No. 20140082676 relating to an interface for wireless data transmission in a vehicle.

A data retrieval device can be stationary or mobile, for example, located in a movable vehicle. Alternatively, a data retrieval device can be remote from a vehicle, but in or can be placed in electronic communication with a vehicle or a display device of interest therein. For example, a telephone or a tablet can serve as a data retrieval device, which can be in wireless or actual communication, for example, with a connecting wire or cable, with a display device of interest, such as, one that is mobile, such as, one located on or in a movable vehicle. A data retrieval device can comprise a data communication device, a data processing device and so on, as known in the art. A data retrieval device receives informational content, such as, a digitized display material file and the like, from a distribution device, as well as, coincidentally in an executable data file, or sequentially, a program that controls and enables display of that file comprising informational content. A data retrieval device also can transmit data to a distribution device or equivalent, such as, display material usage data.

Any vehicle can be used in the practice of the instant subject matter, such as, automobiles, buses, trains, planes, boats, motorcycles, bicycles, scooters, mopeds and so on, essentially any mobile vehicle or means of transportation, which can be motorized, can be used. On smaller vehicles without windows, a display device, such as, an LCD or an LED panel can be secured on or to a vehicle.

In embodiments, a vehicle comprises a transparent, clear or translucent surface. Examples include a glass or a plastic, such as, a polycarbonate or other transparent materials (for example, with strength approaching or approximating that of steel), such as, a windshield, a rear window, a side window, for example, on a door, and so on.

A data display device can be affixed to a structure, for example, to a building or to a vehicle, and is one which accepts processed data and displays data content in the form of, for example, an image, a plurality of images, a series of images, a text, a video and so on, that is, displayed material. Any form of display device that can be affixed to a vehicle or to a building, for example, can be used, such as, an HUD, an LCD, an LED device and so on. Thus, a display device can be a flexible organic LED comprising a flexible substrate, such as, a metallic foil or a plastic. For example, as used with taxis, a prism-shaped structure can be affixed to a roof of an automobile for displaying images, signs, ads and so on. Such a device can be modified to provide an electronic display device in practice of the subject matter of interest.

Another display device can be an LED device or an LCD, particularly one which is affixed to a body panel of a vehicle or to a structure affixed to a vehicle, or substitutes for a banner or a sign in an existing structure, such as, a prism-like structure already used on vehicles to present static signs mentioned hereinabove. Such a display device can be affixed to a building or part thereof, such as, a wall or a window, a sign, a billboard and so on.

Yet another display means or device is electronic paper or a form thereof, which can be an active matrix display; electronic ink; electrowetting display; electrofluidic display; and so on, see, for example, U.S. Pat. Nos. 7,728,811 and 7,733,554, each incorporated herein by reference in entirety. Because electronic paper or electronic ink technology reflects light, such technologies enhance contrast and visibility, particularly under conditions of direct sunlight or bright or high illumination indoors.

Image placement can be adjusted to approximate or to maximize that which can be seen by, for example, a passenger or operator of another, adjacent vehicle or one on or at the exterior of a building, business, store front and so on. For example, a vehicle comprising a display device of interest can display an image in proximity or up to infinity as a design choice. Eyebox of a displayed image can be configured to be larger than normally adapted for a viewer so as to enable viewing from afar or from a greater angle from a perpendicular to a surface of a display device, a combiner and so on. Luminosity and/or contrast can be adjusted to enable viewing from outside an office, a building or a vehicle.

Displays systems are known, see, for example, U.S. Pat. No. 5,917,431 for luminescent display of a traffic signal and U.S. Pat. No. 5,150,116 for a traffic light associated advertisement display device, each incorporated herein by reference in entirety.

A device of interest comprising a data retrieval device and a display device, and can comprise, for example, a CPU, a data transmitting device, a data processing device and a data storage device to store data files of displayed content, programs to display such content and data of such display and so on, also can comprise a motion sensor, such as, an accelerometer, a gyroscope, a compass and the like. A display device may be configured to display informational content only when a device is not in motion, that is, is motionless, no motion is detected. Thus, an image may be presented in a vehicle when that vehicle is stopped or not running. In embodiments, an image is displayed when a vehicle is in motion, for example, to a passenger of a bus, a train, a plane, a driverless or autonomous vehicle, a taxi and so on.

In embodiments, a display device comprises an HUD, systematic vision system and the like, which displays images on a transparent or translucent surface, such as, a glass, a plastic and so on. As known in the art, an HUD device generally comprises an image projector that projects, for example, an image to optical infinity (or comprises a wave guide or holographic device that precludes image projection), and a combiner that captures that projection and provides an image visible and readable by a viewer. An HUD comprises a data processing device, such as, a CPU for enabling display of informational content of interest, a processing device takes a data file of content to be displayed (optionally as an executable file) and communicates that processed information to a display device of interest to produce an image for viewing, and optionally, to obtain and to store information about that displayed content, and a data storage device, for example, a random access memory (RAM) device, a read only memory (ROM) device and so on. An HUD can comprise one or more lens, prisms, mirrors, textured films and the like that manipulate an image, for example, to have an image presented on a combiner in a manner that when perceived by a viewer, is proper, that is, is readable and is intelligible (for example, a projected image may be backwards, upside down, inverted and so on but readable when viewed on or from a combiner), that is, a proper image, to correct for aberrations and distortions or to ensure a visible image is not distorted despite being displayed on a non-planar surface, optics aberration and so on. An HUD can comprise diverging light devices, such as, lens and films, Fresnel devices and other image magnifying devices to enlarge an image on a combiner. A combiner of interest can be more simple than that used in conventional HUD devices because only an image is viewed and not the outside world that is viewed through a combiner as is what occurs in an HUD where a viewer is an operator, for example, a driver or a pilot who views an environment outside of or beyond a glass, such as, the, “road,” before a moving vehicle. Hence, a viewing surface need not be clear, without aberrations and so on. For example, a glass can be tinted, coated or opaque so as to make it difficult for one outside of a vehicle to see in a cabin or cab of a vehicle. Nevertheless, such a tinted, coated or opaque glass can be used in practice of the subject matter of interest as only the image generate by an HUD is viewed, not what can be viewed through the glass. Some automobiles are factory equipped with HUD devices. Essentially any HUD device for a vehicle can be used in practice of the subject matter of interest so long as a device is configured to display an image viewable on the outside of that vehicle as provided herein, or in embodiments, to any viewer, including one inside that vehicle, a device of interest serving as a display device, such as, for a passenger, for example, on a mass transit vehicle, a taxi, a driverless vehicle and so on.

Because, in embodiments, a displayed material is viewed not by a vehicle operator, driver, pilot, office or building employee or owner, and the like adjacent to or at a proximal side of a viewing surface but by a viewer exterior to or at a distal side of a viewing surface, images may have to be manipulated to be proper, to be readable by a viewer outside of a vehicle, office, building and so on. By, “proximal,” is meant the side of a transparent or translucent surface that is closer to a vehicle operator, pilot, business owner, office owner or lessee, and so on. A proximal side is found in the interior of or facing interior of a cabin of a vehicle, such as, a passenger compartment, in an office and so on. For example, in a current and known use of an HUD in a vehicle where an image is configured to be viewed by a driver or operator, a proximal side is one facing interior of the passenger compartment, that is, on the inside surface of a windshield. By, “distal,” is meant the other side of a viewing surface that, in the normal and known use of an HUD in a vehicle, is on the exterior of a vehicle or office, or faces the exterior of a vehicle or office, or faces outside of a vehicle or office. However, as noted hereinabove, while images are displayed on a surface or side opposite of usual or normal operation, for example, outside of a vehicle, in embodiments, images can be displayed inside of a vehicle, for example, when a viewer is not a driver or operator but a passenger in a vehicle, such as, in a mass transit vehicle, a taxi and so on.

In embodiments, for a displayed material to be legible, readable, understandable or of correct orientation as viewed by an individual outside of a vehicle displaying a material of interest, that is, a proper image, a material may need to be projected on or transmitted to a combiner of a viewing surface, such as, a glass, a plastic and so on, in an inverse orientation, a reverse orientation, a backward orientation or the like, any orientation such that displayed material viewed by an intended viewer, such as, a passenger or a viewer outside of an office, in an adjacent vehicle or outside of a business is of correct orientation, order, direction and the like, that is, is a proper image, to be readable, understood, read, viewed and the like by an individual outside an office, a building or a vehicle, as intended by an owner of an original or an owner of an image.

For example, orientation of a displayed material of interest can be analogous to painting signage combining wording and/or lettering on a pane of glass, where a signage is painted on the side of glass facing inside an office, building or vehicle and orientation, direction and the like of numbering and/or lettering must be such that an individual outside that building, office or vehicle facing the side of glass facing outside that building, office or vehicle can read that signage as if typed or photocopied on a piece of paper. To do so, numbering and/or lettering may need to be painted in a reverse, backward, inverse and the like orientation.

For purposes herein, “inverse,” or grammatic forms thereof, such as, “inverted,” is meant in any orientation, direction, form and the like of an original or aside from that found in a proper original so as to be intelligible, readable, understandable and the like by an intended viewer, such as, an individual outside of a building, office or vehicle displaying an image, information or material of interest. Thus, an original or parts thereof may be inverted and is proper. An image or parts thereof may be inverted and is proper.

Hence, for example, for certain stereospecific capital letters to be intelligible by a viewer outside of a sign painted on the inside surface of a clear glass of a building, office or vehicle, for a word, such as, “BAKERY,” to be readable from the outside face or side of the glass, some letters thereof may need to be applied to the inside face or side of a glass in reverse order, such as, “YREKAB.” Also, for example, some letters, such as those which are stereospecific, are applied inverted, for example, “E,” is painted as, “∃,” “R” is painted as, “ [symbol] ,” and so on, on the inside surface of a glass. Hence, a proper image on the outside essentially replicates the intended word whereas a proper original on the inside of the glass can contain backwards, inverted and so on numbering and lettering.

In embodiments, for example, depending on optics used, digitized data encoding displayed material of interest can be written or coded so that processed and displayed, a letter or an image can be, for example, inverted, for example, on a transparent or translucent surface of an office, business or vehicle so that an individual exterior to or outside of an office, a building or a vehicle, can read, view, understand and the like material displayed on or by a distal face of a transparent or translucent surface, where that inverted letter is proper from standpoint of a viewer. As known in the art, lens, mirrors, textured films, such as, a Fresnel film lens and the like, can be used to ensure a proper image is of appropriate size, clarity and so on to be readable, intelligible and understandable by a viewer of an image, however presented, as intended by an owner of an object or of an image.

In embodiments, such displayed material manipulation may not be as extreme or may not be needed depending on a display device, a transparent or translucent surface and so on, which may carry modifications or be appended to comprise activities attributed to, for example, a prism, a lens and the like that are known to alter orientation of a displayed or viewed material, minimize aberrations and so on, and may include characters, lettering and/or numbering that are not stereospecific and so on.

In embodiments, a display device can be one which provides a selective presentation of a displayed material. For example, a displayed material outside of a vehicle can be visible only when a vehicle is motionless, is braked, such as, at a stop sign or at a stoplight, when parked and so on. Thus, information content may not to be displayed when a vehicle is in motion, is moving. In embodiments, images can be displayed in a vehicle that is moving, for example, to a passenger in a moving vehicle, such as, a flying aircraft, a moving train, a driving bus, a driving taxi and so on. In embodiments, an image may be displayed when a storage battery contains charge or is charging, for example, a moving vehicle or a vehicle comprising regenerative braking.

In embodiments, messages can be displayed on one or more surfaces relating to safety, to a warning, to indicate a disabled vehicle and so on, such as, a safety sign, a first aid sign, for example, requesting assistance, and so on. Thus, a vehicle on a roadside can display such signage using a display device of interest to announce location to first responders, to request aide from passing motorists and so on.

In embodiments, an HUD display is configured so that an image is projected onto a combiner outside of or on a distal side of an office, a building or a vehicle. That can occur, for example, if a projector is sited outside of an office, a building or a vehicle, for example, for projection onto an outside surface of a driver door window, a projector may be sited in a housing of a rear view mirror. In embodiments, a projector is on or in an office, a building or a vehicle and one or more lens, mirrors, films and the like are used to channel a projected image to outside of an office, a building or a vehicle for projection onto a combiner. In embodiments, a wave guide is used to channel an image to outside of an office, a building or a vehicle.

A display device, as well as a data retrieval device of an electric device of interest can be powered by an electrical generating system of a vehicle, by a dedicated power storage device or both. When not running, a device of interest can be powered by a dedicated energy storage device to avoid draining a vehicle storage battery. Other means of powering an electric device of interest are contemplated, such as, solar panels or films, wind turbines or generators, and so on which may charge a dedicated battery for display use, so long as a charge is stored. Energy storage devices generally operate with direct current and when a device of interest is, for example, associated with a moving vehicle or other structure that relies on a storage battery, a device of interest is configured to operate with a direct current electric charge. In embodiments, a device of interest is situated in a building or other structure which is associated with alternating current for electric power, and a device of interest is configured to operate with alternating current electric power. Other power sources can be used and a device of interest is configured to be operable therewith.

Opportunity to display information provides a source of information relating to degree of information dissemination, impact or efficacy of information dissemination and so on, for example, for sociologic study, psychologic study, marketing study, business study, safety study and so on. Such data can be used to enhance impact and efficacy of information dissemination, marketing, demographics, sales and so on.

Opportunity to display data also provides a source of marketing revenue of digital information display, for example, an owner of distribution devices, an owner of an original, an owner of an image, an individual that allows content display from an article, a building, a structure and so on under control of said individual, an operator or owner of a vehicle, and so on. Revenue can be graded, based on, for example, time of day in which information is displayed, length of time information is displayed, where information is displayed, possible audience of displayed information, density of displayers in a locale, impact of information display and so on, as a design choice. Data of display can be stored in a data storage device of interest. That data can be transmitted to a remote computer, such as, a distribution device. For example, tracking of data display can be monitored by an on-board electric device of interest, optionally, correlated with GPS information, and transmitted to a distribution device or equivalent. Data then can be analyzed and a formulation or predetermined set of conditions can be applied to determine amount of revenue generated by aggregate display of content and, for example, analysis of associated data and material, and “metadata,” associated with displayed content. Calculated revenue or proceeds then are transferred to an owner, lessee, renter and the like; driver or owner of a vehicle that displayed content or material; and so on as a design choicer.

In embodiments, display devices of interest located in plural, remote sites can be in communication therebetween or thereamong to enable communication between or among display device owners, for example, for social interaction, business or other purposes, to enable data exchange, for example, on display characteristics and so on.

All references cited herein are herein incorporated by reference in entirety.

It will be evident to the artisan that various changes and modifications can be made to the teachings herein without departing from the spirit and scope of the invention.

1. A device to display an electronic image on a vehicle, comprising a head up display device for displaying said electronic image, said head up display comprising a collimating device, wherein information displayed by said device is variable, wherein data comprising said information is communicated wirelessly to said device from a remote information distribution device, wherein said device to display an image comprises a data storage device and a data processing device to store data of said displayed image and a data transmitting device to communicate said data of said displayed image to said information distribution device, and wherein said information distribution device comprises a data storage device and a data processing device comprising a program to determine revenue from said displayed image.

2. (canceled)

3. The device of claim 1, wherein said electronic image is displayed on a translucent or a transparent surface of said vehicle.

4. The device of claim 3, wherein said transparent or translucent surface comprises a glass or a plastic.

5. (canceled)

6. The device of claim 1, comprising a wave guide.

7. The device of claim 1, wherein said electronic image is projected by a cathode ray tube.

8. The device of claim 1, wherein said electronic image is projected by a solid state light source.

9. The device of claim 1, wherein said electronic image is projected by a laser.

10. The device of claim 1, comprising a diode.

11.-12. (canceled)

13. The device of claim 1, comprising a motion sensor.

14. The device of claim 1, comprising an accelerometer.

15. A vehicle comprising the device of claim 1.

16. The vehicle of claim 15, wherein said electronic image is displayed on a window or windshield.

17. The vehicle of claim 15, said electronic image is displayed inside, outside or both of said vehicle.

18.-20. (canceled)
